(19) United States
(12) Patent Application Publication
(10) Pub. No.: US 2008/0044559 A1
(43) Pub. Date: Feb. 21, 2008

(54) Method for forming metal pattern flat panel display using metal pattern formed by the method

(75) Inventors: Chang Ho Noh, Yongin-si (KR); Tamara Byk, Yongin-si (KR); Sung Hen Cho, Yongin-si (KR); Ki Yong Song, Yongin-si (KR); T.V. Gaevskaya, Minsk (BY); V.G. Sokolov, Minsk (BY)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/727,424

(22) Filed: Mar. 27, 2007

(30) Foreign Application Priority Data
Aug. 17, 2006 (KR) 10-2006-0077561

(51) Int. Cl. G09G 3/00; B41M 5/00

(52) U.S. Cl. 427/145; 345/30

(57) ABSTRACT

Disclosed herein is an improved method for forming a metal pattern with low contact resistance. The metal pattern may be applied to various flat panel display devices with high resolution. Further disclosed is a flat panel display using a metal pattern formed by the method.

### CROSS-REFERENCE TO RELATED PATENT APPLICATION

This non-provisional application claims priority under 35 U.S.C. § 119(a) on Korean Patent Application No. 10-2006-0077561 filed on Aug. 17, 2006, the disclosure of which is herein incorporated in its entirety by reference.

### BACKGROUND OF THE INVENTION

1. Field of the Invention

The present invention relates to an improved method for forming a metal pattern with a low contact resistance and a flat display using a metal pattern formed by the method.

2. Description of the Related Art

With increasing demand for large display areas and flat panel displays with high resolution (e.g., liquid crystal display devices (LCDs), plasma display panels (PDPs), electroluminescent displays (ELDs) and vacuum fluorescent displays (VFDs), the length of metal lines is considerably increased and the design rule for the increased aperture ratio is decreased. This causes problems, such as a drastic increase in line resistance and capacitance, and signal delay and distortion. Under these circumstances, development of a process for forming a metal line with low resistivity and low contact resistance is essential to developing high-resolution and large-area flat panel display devices.

In this connection, a method is reported, in which a metal catalyst capable of acting as a seed is used to fabricate a thin film. The use of the metal catalyst reduces the contact resistance between a semiconductor layer and an ohmic contact layer. Furthermore, it is reported to use a resistance-reducing layer formed of titanium (Ti) and a palladium (Pd) catalyst layer for silver plating to form a wiring of a semiconductor device. However, these methods involve complicated and costly processes to form a pattern, such as a formation of a metal thin film, which requires high vacuum/high temperature conditions and a photolithography process which uses a photoresist and includes exposure and etching. Therefore, these process are economically disadvantageous in terms of processing and cost.

A method for forming a metal pattern has been reported in which a silane layer and an aqueous Pd colloidal solution are applied to a glass substrate to form a nucleus for crystal growth, and the resulting substrate is irradiated with a laser beam, followed by electroless plating to form a metal pattern on the unexposed areas of the substrate. This method also has disadvantages in that additional surface treatment is needed and a laser light source with high power is used as an exposure source.

The present inventors have developed methods for forming high-conductivity metal patterns using a photocatalytic compound and optionally a water-soluble polymer in a simple and economical manner, which does not involve a process for forming a metal thin film or an exposure process for forming a fine shape and a subsequent etching process.

According to these methods, a same photocatalytic compound (e.g., TiO₂) is used to form a metal pattern and a gate insulating layer. As a result, the methods can be advantageously applied to the fabrication of a bottom contact electrode structure in which source/drain electrodes 5 and 6 are formed on a gate insulating layer 3 and a semiconductor layer 4 is formed thereon, as shown in FIG. 1. However, it is difficult to apply these methods to a top contact electrode structure, which is a general type for LCD operation, in which a semiconductor layer 4′ is formed on a gate insulating layer 3′ and source/drain electrodes 5′ and 6′ are formed on the semiconductor layer, as shown in FIG. 2. These difficulties are attributed to high contact resistance between the semiconductor layer and the source/drain electrodes.

### SUMMARY OF THE INVENTION

In one embodiment, the present invention provides an improved method for forming a metal pattern with low contact resistance that can be applied to top contact electrode structures as well as bottom contact electrode structures.

In another embodiment, the present invention provides a flat panel display with high resolution, which includes a metal pattern formed by the method.

In accordance with one aspect of the present invention, there is disclosed a method for forming a metal pattern which includes (a) applying a solution containing a photocatalytic compound, a metal catalyst compound and a photosensitizer to a substrate to form a photocatalytic metal layer on the substrate, (b) selectively exposing the photocatalytic metal layer to light to form a latent pattern, and (c) plating the latent pattern with at least one metal to grow a metal crystal thereon, thereby forming a metal pattern of at least one layer.

The method may further includes, after step (b), removing metal ions remaining in the unexposed portion by treating the exposed photocatalytic metal layer with a solvent.

In accordance with another aspect of the present invention, there is provided a flat panel display comprising a metal pattern formed by the method.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic cross-sectional view showing an electrode structure of a bottom contact thin film transistor (TFT) for LCD operation;

FIG. 2 is a schematic cross-sectional view showing an electrode structure of a top contact TFT for LCD operation;

FIG. 3 shows schematic diagrams illustrating a method for forming a metal pattern according to one embodiment of the present invention; and

FIG. 4 shows schematic diagrams illustrating a method for forming a metal pattern according to another embodiment of the present invention.

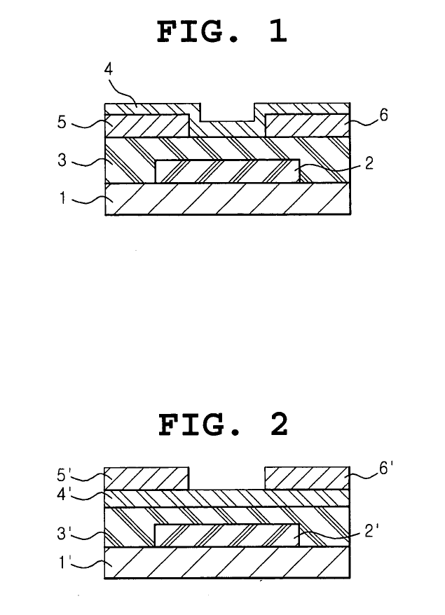

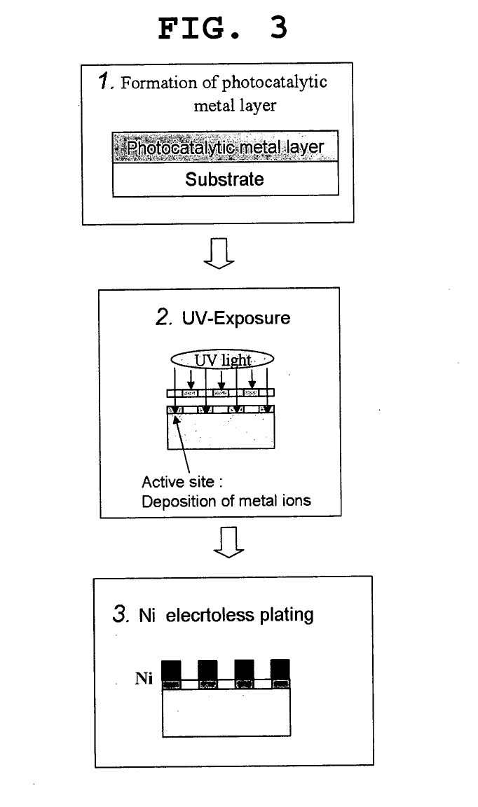

### DESCRIPTION OF THE PREFERRED EMBODIMENTS

The present invention will now be described in greater detail.

In one aspect, the present invention provides a method for forming a metal pattern which includes (a) applying a solution containing a photocatalytic compound, a metal catalyst compound and a photosensitizer to a substrate to form a photocatalytic metal layer on the substrate, (b) selectively exposing the photocatalytic metal layer to light to form a latent pattern, and (c) plating the latent pattern with at least one metal to grow a metal crystal thereon.

In one embodiment, the method further includes, after step (b) and prior to step (c), removing metal ions remaining in the unexposed portion by treating the exposed photocatalytic metal layer with a solvent.

The latent pattern acts as a nucleus for crystal growth. The metal pattern may be of at least one layer.

According to the method of the present invention, the use of a combination of a highly conductive metal catalyst compound and a photocatalytic compound to form the photocatalytic metal layer improves the adhesion and electrical contact properties between a semiconductor layer and source/drain electrodes. The metal pattern formed by the method has low contact resistance and high conductivity. Therefore, the method may be applied to the fabrication of a top contact electrode structure.

In addition, the method according to one embodiment of the present invention omits a catalyst activation, for example baking of a photocatalytic compound, or the formation of a water-soluble polymer layer on a photocatalytic film layer, the latent pattern may be formed by a so-called ‘one-step process,’ which enables the formation of a highly stable metal pattern with high resolution in a simple and economical manner. Therefore, the method of the present invention can be easily applied to the fabrication of a variety of flat panel displays, including LCDs, PDPs, ELDs and VFDs.

A more detailed explanation of the respective steps of the method according to the present invention will be provided below.

### Step (a):

In this step, a solution containing a photocatalytic compound, a metal catalyst compound and a photosensitizer is applied to one surface of a substrate to form a photocatalytic metal layer.

The term “photocatalytic compound” as used herein refers to a compound whose characteristics are drastically changed by light. The photocatalytic compound is inactive when not exposed to light, but becomes active upon exposure to light, e.g., UV light, and exhibits enhanced reactivity.

When the photocatalytic compound is exposed to light, electron excitation occurs in the exposed portion to allow the photocatalytic compound to exhibit activity, e.g., reducibility. Accordingly, reduction of metal ions in the exposed portion takes place to provide a negative pattern. Examples of such photocatalytic compounds are Ti-containing organometallic compounds which can form transparent amorphous TiOₓ (x is a number not greater than 2) upon exposure to light. Examples of preferred Ti-containing organometallic compounds include, but are not limited to, tetraisopropyl titanate, tetra-n-butyl titanate, tetrakis(2-ethyl-hexyl)titanate, and polybutyl titanate.

The term “metal catalyst compound” as used herein refers to a compound containing metal ions in which, upon exposure to light, the metal ions are reduced and deposited in the exposed portion by the action of the photocatalytic compound, and the deposited metal particles play a role as catalysts accelerating growth of a metal crystal in the subsequent plating step.

The metal catalyst compound interacts with the photocatalytic compound to allow the final metal pattern to have a densely packed structure, and serves to lower the Schottky barrier and contact resistance between source/drain electrodes and an underlying semiconductor layer to effectively allow the final metal pattern to have superior performance.

The metal catalyst compound is not particularly restricted. In one embodiment, the metal catalyst compound is suitably selected taking into consideration the adhesion to the substrate used, the contact properties with the substrate, an insulating film or a semiconductor layer, and the kind of metals used in the subsequent plating step. Examples of the metal catalyst compound include, but are not limited to, silver (Ag) salt compounds, palladium (Pd) salt compounds, and mixtures thereof.

Metal catalyst compounds have been used in a process of forming a metal pattern layer. E.g., U.S. Patent Application Publication No. 2006/0097622 A1. However, U.S. 2006/0097622 A1 does not teach a use of a solution comprising a photocatalytic compound, metal catalyst compound and photosensitizer to form a photocatalytic metal layer.

The photosensitizer functions to increase the photosensitivity of the photocatalytic metal layer upon exposure to light, resulting in an improvement in the activity of the photocatalytic compound and the metal catalyst compound. As the photosensitizer, there can be used at least one water-soluble compound selected from colorants, organic acids, organic acid salts, and organic amines. Examples of the photosensitizer include tar colorants, potassium and sodium salts of chlorophylline, riboflavin and derivatives thereof, water-soluble annatto, CuSO₄, caramel, curcumine, cochineal, citric acid, ammonium citrate, sodium citrate, glycolic acid, oxalic acid, potassium tartrate, sodium tartrate, ascorbic acid, formic acid, triethanolamine, monoethanolamine and malic acid, but are not limited thereto.

A solution of the photocatalytic compound, the metal catalyst compound and the photosensitizer in a suitable solvent is applied to one surface of a substrate by a general coating technique. Suitable solvents may be an alcohol-based solvent. Non-limiting examples of such solvents include isopropanol, 1-butanol, ethanol, propanol, and pentanol. The general coating technique may include spin coating, spray coating or screen printing.

The contents of the photocatalytic compound, the metal catalyst compound and the photosensitizer in the solution may be properly selected and determined by those skilled in the art according to the desired applications of the solution. The photocatalytic compound, the metal catalyst compound and the photosensitizer may be present in an amount of about 0.01 to 50%, about 0.01 to 30%, and about 0.01 to 10% by weight, respectively, but their contents are not limited to these ranges. The solution of the photocatalytic compound includes a remainder of a solvent.

Examples of substrates that can be used in the method of the present invention include, but are not especially limited to, substrates made of semiconductor materials and transparent conductive film substrates. Any semiconductor materials can be used to form the substrate so long as they are commonly used in the art. The substrate may be a silicon wafer. Specific examples of suitable semiconductor materials include amorphous silicon, polysilicon and crystalline silicon. The transparent conductive film substrates are not especially limited so long as they are commonly used in the art. In one embodiment, the substrate is a glass or plastic substrate whose one surface may be coated with a transparent conductive material. Examples of such transparent conductive materials include indium tin oxide (ITO), indium zinc oxide (IZO), and fluorine-doped tin oxide (FTO). Non-limiting examples of materials for the plastic substrates include acrylic resins, polyesters, polycarbonates, polyethylenes, polyethersulfones, olefin-maleimide copolymers, and norbornene-based resins.

On the other hand, the formation of the photocatalytic metal layer requires no high-temperature baking after the coating. Instead, light exposure can be carried out in a state in which the photocatalytic metal layer is spin dried, immediately after the coating, to form a latent pattern acting as a nucleus for crystal growth. The catalytic activity of the latent pattern is maintained for at least one hour after the light exposure, so that the final metal pattern has high resolution and is highly sterically stable.

### Step (b):

In this step, the photocatalytic metal layer formed in step (a) is selectively exposed to light, e.g., UV light, through a photomask to form a latent pattern. The latent pattern acts as a nucleus for crystal growth which consists of an activated portion and an inactivated portion.

At this time, exposure atmospheres and exposure doses are not especially limited and may be properly selected according to the kind of the photocatalytic compound and metal catalyst compound used. To attain sufficient catalytic activity, the photocatalytic metal layer is preferably irradiated in a UV exposure system at about 200 to 1,500 W for about 1 second to 3 minutes, but these exposure conditions are not limited.

As explained earlier, when the photocatalytic metal layer is exposed to light, electron excitation occurs in the exposed portion to allow the photocatalytic compound to exhibit activity, e.g., reducibility. Accordingly, reduction and deposition of metal ions present within the metal catalyst compound take place to promote the growth of a metal crystal in the subsequent plating step.

If necessary, after the exposure, the photocatalytic metal layer, which is exposed to light, may be treated with a solvent to remove metal ions remaining in unexposed portions of the photocatalytic metal layer. The presence of large quantities of metal ions in the unexposed portions may impede the reduction of the metal ions in the subsequent plating step. This can be avoided by treating the photocatalytic metal layer, which is exposed to light, with a solvent to remove the metal ions. The solvent treatment also removes residues of the water-soluble photocatalytic compound and the photosensitizer from the unexposed portions.

The solvent may be selected from, but not limited to, alcohol-based solvents, e.g., isopropanol and 1-butanol, water, and mixtures thereof. The solvent treatment is preferably conducted for about 10 seconds to about 5 minutes. When it is intended to use an aqueous alcoholic solution for the solvent treatment, an alcohol-based solvent is preferably present in an amount of about 5-100 vol % in the solution.

### Step (c):

In this step, the latent pattern formed in step (b) is plated with at least one metal to form a metal pattern of at least one layer. Specifically, the latent pattern is plated with a desired metal to form a metal monolayer or a first metal layer, and optionally, the metal monolayer or first metal layer is plated with another desired metal to form a second metal layer on the first metal layer, thereby completing formation of a multilayer metal pattern. The plating may be performed by electroless plating or electroplating.

The kind and plating order of the metals may be properly selected by those skilled in the art according to the desired application. When it is intended to form a multilayer metal pattern of two layers or more, the respective metal layers may be formed of the same or different metals. Examples of suitable metals that can be used in the method of the present invention include, but are not limited to, Ni, Pd, Cu, Ag, Mo, Cr, Au, Co, Al, Sn, Zn, and alloys thereof.

The thickness of the metal layer may be suitably controlled, if needed. The metal layer has a thickness of about 0.01 to 10 μm. In another embodiment, the metal layer has a thickness of about 0.1 to 2 μm.

Taking into consideration the adhesion to the substrate and the contact properties with the substrate, an insulating film or a semiconductor layer, a multilayer metal pattern including a highly conductive metal, such as Cu, Ni or Ag, may be formed by plating the latent pattern with Ni, Pd, Sn, Zn or an alloy thereof to form a first metal layer and plating the first metal layer with a highly conductive metal, such as Cu, Ag, Au or an alloy thereof, to form a second metal layer. In one embodiment, in view of costs and ease of formation, the first metal layer is formed of Ni and the second metal layer is formed of Cu or Ag.

A third metal layer may be further formed on the second metal layer. In the case where a transparent conductive material, e.g., ITO, or a semiconductor material must be in contact with the second metal layer, the third metal layer may be formed by plating the second metal layer with Ni, Pd, Sn, Zn or an alloy thereof in order to improve the contact resistance between the second metal layer and the conductive material or semiconductor material. When the second metal layer is formed of copper, the third metal layer may be formed of a noble metal, e.g., Ag or Au, in order to avoid deterioration in the physical properties of the final metal pattern due to the formation of an oxide film on the surface of the second metal layer. For better contact resistance, the third metal layer may be formed by plating the second metal layer with the same metal as that used to form the first metal layer.

Plating processes for the formation of the multilayer metal pattern are not particularly restricted, and can be appropriately combined, if needed. For example, the first metal layer may be formed by electroless plating and the second metal layer may be formed using Cu or Ag by electroless plating or electroplating.

The electroless plating or electroplating is achieved using a general plating composition in accordance with a well-known procedure. The electroless plating is performed by dipping the substrate, on which the latent pattern acting as a nucleus for crystal growth is formed, in a plating solution containing, for example, 1) a metal salt, e.g., a Ni, Cu or Ag salt, 2) a reducing agent, 3) a complexing agent, 4) a pH-adjusting agent, 5) a pH buffer, and 6) a modifying agent.

The metal salt 1) serves as a source providing metal ions to the substrate. The metal salt is preferably in the form of chloride, nitrate, sulfate and acetate.

The reducing agent 2) acts to reduce metal ions present on the substrate. Examples of the reducing agent may include NaBH₄, KBH₄, NaH₂PO₂, hydrazine, formalin, and polysaccharides (e.g., glucose). In one embodiment, NaH₂PO₂ is used in a nickel plating solution, and formalin or polysaccharide is used in a Cu or Ag plating solution.

The complexing agent 3) functions to prevent the precipitation of hydroxides in an alkaline solution and to control the concentration of free metal ions, thereby preventing the decomposition of the metal salt and adjusting the plating speed. Examples of the complexing agent may include ammonia solution, acetic acid, Guanine, tartaric acid salt, chelating agents (e.g., EDTA), and organic amine compounds. In one embodiment, chelating agents (e.g., EDTA) may be used.

The pH-adjusting agent 4) serves to adjust the pH of the plating solution, and is an acidic or basic compound. The pH buffer 5) inhibits sudden changes in the pH of the plating solution, and may be selected from organic acids and weakly acidic inorganic compounds. The modifying agent 6) is a compound capable of improving coating and planarization characteristics. Examples of the modifying agent include common surfactants and adsorptive substances capable of adsorbing components interfering with the crystal growth.

Electroplating may be performed using a plating composition comprising, for example, 1) a metal salt, 2) a complexing agent, 3) a pH-adjusting agent, 4) a pH buffer, and 5) a modifying agent. The functions and the examples of the components contained in the plating solution composition are as defined above.

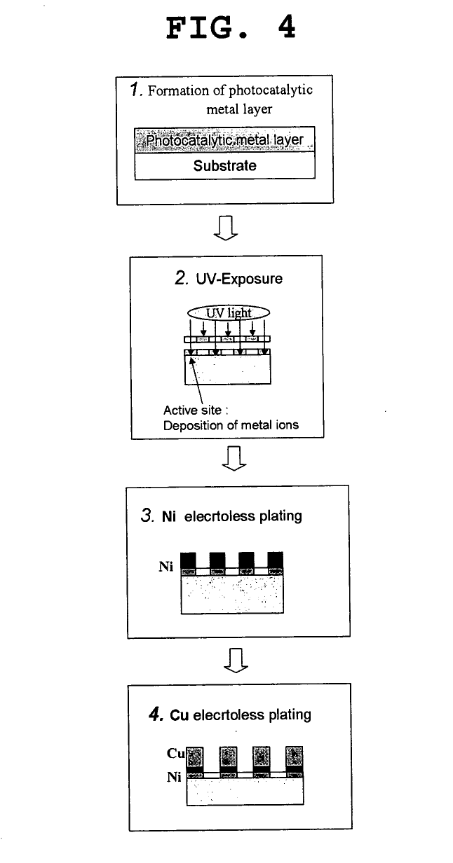

FIGS. 3 and 4 show embodiments of the method according to the present invention. Specifically, FIG. 3 shows schematic diagrams illustrating a method for forming a monolayer metal pattern containing Ni, and FIG. 4 shows schematic diagrams illustrating a method for forming a multilayer metal pattern containing a Ni layer and Cu layer.

Hereinafter, the constitution and effects of the present invention will be explained in more detail with reference to the following examples. However, these examples serve to provide further appreciation of the invention but are not meant in any way to restrict the scope of the invention.

### EXAMPLES

### Example 1

A solution (6 mL) of polybutyl titanate (2.5 wt %) in isopropanol, a solution (3 mL) of oxalic acid (5 wt %) in isopropanol, a solution (5 mL) of PdCl₂ (0.7 g) and HCl (0.5 mL) in isopropanol (5 mL), and 10 mL of 1-butanol were mixed together to prepare a solution (24 mL). The solution was applied to an ITO-glass substrate by spin coating at 500-2,000 rpm. The coated substrate was irradiated with UV rays at 500 W using a UV exposure system (Oriel, U.S.A.) in a broad range of wavelengths for one minute. The exposed substrate was thoroughly washed with an aqueous isopropanol (10 vol %) solution for at least one minute to remove Pd ions (Pd²⁺) remaining in the unexposed portion. Subsequently, the clean substrate was again washed with water with slow shaking, and was then dipped in an electroless nickel plating solution having the composition (a) indicated in Table 1 to grow a crystal on the patterned metal line, completing formation of a negative type nickel line pattern. The basic physical properties of the pattern are shown in Table 2. The thickness, contact resistance and resolution of the pattern were measured using an alpha-step (manufactured by Dektak), a combination of a probe station and a parameter analyzer (HP 4145®), and an optical microscope, respectively.

### Example 2

The nickel line pattern formed in Example 1 was dipped in an electroless copper plating solution having the composition (b) indicated in Table 1 to form a negative type nickel-copper line pattern. The basic physical properties of the pattern are shown in Table 2.

### Example 3

A negative type nickel line pattern was formed in the same manner as in Example 1, except that a silicon wafer was used instead of the ITO-glass substrate. The basic physical properties of the pattern are shown in Table 2.

### Example 4

A negative type nickel-copper line pattern was formed in the same manner as in Example 2, except that a silicon wafer was used instead of the ITO-glass substrate. The basic physical properties of the pattern are shown in Table 2.

TABLE 1

| (a) Electroless nickel | | | (b) Electroless copper | | |
|---|---|---|---|---|---|
| plating solution | | | plating solution | | |
| NiCl₂•6H₂O | 10 | g | CuSO₄•5H₂O | 12 | g |
| NaH₂PO₂•2H₂O | 30 | g | KNaC₄H₄O₆•6H₂O | 55 | g |
| NaCH₃COO | 10 | g | NaOH | 18 | g |
| NH₄Cl | 40 | g | Na₂CO₃ | 10 | g |
| Water | 1 | l | Na₂S₂O₃•5H₂O | 0.0002 | g |
| pH 7, 5~10 min, | | | CH₂O (40%) | 20 | mL/L |
| 50° C. | | | 5~10 min, | | |
| Thickness of | | | 50° C. | | |
| Ni >0.01 μm | | | Thickness of | | |
| | | | Cu >0.01 μm | | |

TABLE 2

| | | Contact resistance | Resolution |
|---|---|---|---|
| Example No. | Thickness of metal (μm) | (mohm cm²) | (μm) |
| Example 1 | 0.3 (Ni) | 1.6 | 3–5 |
| Example 2 | 0.3 (Ni) + 0.15 (Cu) | 0.9 | 5 |
| Example 3 | 0.2–0.3 (Ni) | 180 | 3–5 |
| Example 4 | 0.2 (Ni) + 0.3 (Cu) | 100 | 5 |

As apparent from the above description, low contact resistance metal patterns can be formed by coating, exposure and plating in a simple manner. The low contact resistance metal patterns may be applied to bottom contact electrode structures as well as top contact electrode structures. In addition, highly stable metal line patterns with high resolution and high conductivity can be formed in a rapid and efficient manner, without involving complicated processes, such as sputtering under high vacuum conditions, photopatterning, development and etching. Therefore, the method of embodiments of the present invention can be applied to the fabrication of a variety of flat panel displays, including LCDs, PDPs, ELDs and VFDs.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for forming a metal pattern, the method comprising:
(a) applying a solution containing a photocatalytic compound, a metal catalyst compound and a photosensitizer to a substrate to form a photocatalytic metal layer on the substrate;
(b) selectively exposing the photocatalytic metal layer to light to form a latent pattern; and
(c) plating the latent pattern with at least one metal to grow a metal crystal thereon.

2. The method according to claim 1, wherein the photocatalytic compound is a titanium-containing organometallic compound.

3. The method according to claim 2, wherein the photocatalytic compound is tetraisopropyl titanate, tetra-n-butyl titanate, tetrakis(2-ethyl-hexyl) titanate, or polybutyl titanate.

4. The method according to claim 1, wherein the metal catalyst compound is a silver (Ag) salt compound, a palladium (Pd) salt compound, or a mixture thereof.

5. The method according to claim 1, wherein the photosensitizer is at least one water-soluble compound selected from the group consisting of colorants, organic acids, organic acid salts, and organic amines.

6. The method according to claim 5, wherein the photosensitizer is selected from the group consisting of tar colorants, potassium and sodium salts of chlorophylline, riboflavin and derivatives thereof, water-soluble annatto, CuSO₄, caramel, curcumine, cochineal, citric acid, ammonium citrate, sodium citrate, glycolic acid, oxalic acid, potassium tartrate, sodium tartrate, ascorbic acid, formic acid, triethanolamine, monoethanolamine, malic acid, and mixtures thereof.

7. The method according to claim 1, wherein the solution of step (a) contains about 0.01 to 50% by weight of the photocatalytic compound, about 0.01 to 30% by weight of the metal catalyst compound, about 0.01 to 10% by weight of the photosensitizer, and a remainder of a solvent.

8. The method according to claim 1, wherein the substrate is a substrate made of a semiconductor material or a transparent conductive film substrate.

9. The method according to claim 8, wherein the substrate is a silicon wafer made of a semiconductor material selected from the group consisting of amorphous silicon, polysilicon and crystalline silicon.

10. The method according to claim 8, wherein the substrate is a glass or plastic substrate whose one surface is coated with a transparent conductive material selected from the group consisting of indium tin oxide (ITO), indium zinc oxide (IZO), and fluorine-doped tin oxide (FTO).

11. The method according to claim 1, wherein the exposing the photocatalytic metal layer to light in step (b) is performed by irradiating the photocatalytic metal layer with UV rays of about 200 to 1,500 W.

12. The method according to claim 1, wherein the metal used in step (c) is selected from the group consisting of Ni, Pd, Cu, Ag, Mo, Cr, Au, Co, Al, Sn, Zn, and alloys thereof.

13. The method according to claim 1, wherein, in step (c), the plating is performed by electroless plating or electroplating.

14. The method according to claim 1, wherein step (b) further comprises treating the photocatalytic metal layer with a solvent to remove metal ions remaining in portions of the photocatalytic layer which are not exposed to light.

15. The method according to claim 14, wherein the solvent is an alcohol-based solvent, water, a mixture thereof.

16. The method according to claim 1, wherein the metal pattern has a thickness of about 0.01 to 10 μm.

17. A flat panel display comprising a metal pattern formed by a method comprising:
(a) applying a solution containing a photocatalytic compound, a metal catalyst compound and a photosensitizer to a substrate to form a photocatalytic metal layer on the substrate;
(b) selectively exposing the photocatalytic metal layer to light to form a latent pattern; and
(c) plating the latent pattern with at least one metal to grow a metal crystal thereon.
